(19) United States
(12) Patent Application Publication
(10) Pub. No.: US 2005/0119699 A1
(43) Pub. Date: Jun. 2, 2005

(54) Vibrating pacifier

(76) Inventor: Fesal K. Sari, Miami, FL (US)

Correspondence Address: Ruben Alcoba, 17347 SW 20th CT, Miramar, FL, 33029, US

(21) Appl. No.: 10/724,431

(22) Filed: Nov. 28, 2003

(51) Int. Cl. A61J 17/00

(52) U.S. Cl. 606/234; 606/235

(57) ABSTRACT

The present invention is directed to a vibrating pacifier. The vibrating pacifier comprises of a holder, the holder has a circular holding section and a housing section, a battery operated motor housed within the housing section of the holder, wherein the motor has a vibrating end, a shield that surrounds the body of the housing section of the holder, and a mouthpiece shaped to conform to the shape of a child's gums that is attached to the housing section of the holder and that is further attached to the vibrating end of the motor. In another embodiment of this invention, the mouthpiece has a plurality of bumps extending outward from the sections of the mouthpiece that conform to shape of a child's gums.

### BACKGROUND

There is a need for a vibrating pacifier that will massage the gums of an infant when teething.

Throughout time, parents share their infant's suffering when their infants go through the teething process. Attempts have been made to solve this problem. For example, cold wet washcloths were given to infants to bite on. As time progressed, a slew of teething rings, frozen and not, where developed. The problem with teething rings was that, more often or not, the rings would not remain in the infant's mouth due to their shapes. Most infants do not have the coordination to maintain a ring in their mouth for an extended period of time.

U.S. Pat. No. 6,468,294 B2 discusses many of the prior Patents attempting to address the necessity of this invention. The '294 patent states that prior patents had the following disadvantages: the pacifiers were heavy, the vibrational elements of the pacifiers were geared to disturb the child rather that pacify the child, the weight distribution of the pacifiers pulled the pacifiers out of the infants mouth, and the pacifiers could be disassembled by the infants.

The '294 patent shows a device that vibrates the palate of the infants mouth rather than the gums of the child. The patent does not address the need that this invention satisfies. It fails to massage the gums of a child.

An object of the present invention is to relieve the pain a child experiences when teething because of the configuration of the U-shaped biting element of this invention.

Another object of this invention is to provide a device that a child can bite evenly with the majority of his gums, thereby preventing teeth displacement.

A further object of this invention is to provide a device that a child can maintain in his mouth with out the aid of his hands.

Yet, another object of this invention is to provide a device that will automatically turn-off after preset period.

Lastly, another object of this invention is to provide a device that will soothe a child while going to sleep.

### SUMMARY

The present invention is directed to a vibrating pacifier device that satisfies the needs mentioned above. The vibrating pacifier comprises of a holder, the holder has a circular holding section and a housing section, a battery operated motor housed within the housing section of the holder, wherein the motor has a vibrating end, a shield that surrounds the body of the housing section of the holder, and a mouthpiece shaped to conform to the shape of a child's gums that is attached to the housing section of the holder and that is further attached to the vibrating end of the motor. In another embodiment of this invention, the mouthpiece has a plurality of bumps extending outward from the sections of the mouthpiece that conform to shape of a child's gums.

This invention is not limited in its application to the details of the construction and to arrangement of components set forth in the following description or illustrated in the drawings. This invention is capable of other embodiments and of being practiced and carried out in various ways. It is also to be understood that the phraseology and terminology being used in this application are for the purposes of the description and should not be regarded as limiting.

### DRAWINGS

These and other features, aspects, and advantages of the present invention will become better understood with regard to the following description, appended claims, and accompanying drawings where:

FIG. 1 shows a cross sectional view of a vibrating pacifier;

FIG. 2 shows a cross sectional of another embodiment of the vibrating pacifier; and

FIG. 3 show a perspective the mouthpiece of the vibrating pacifier.

### DESCRIPTION

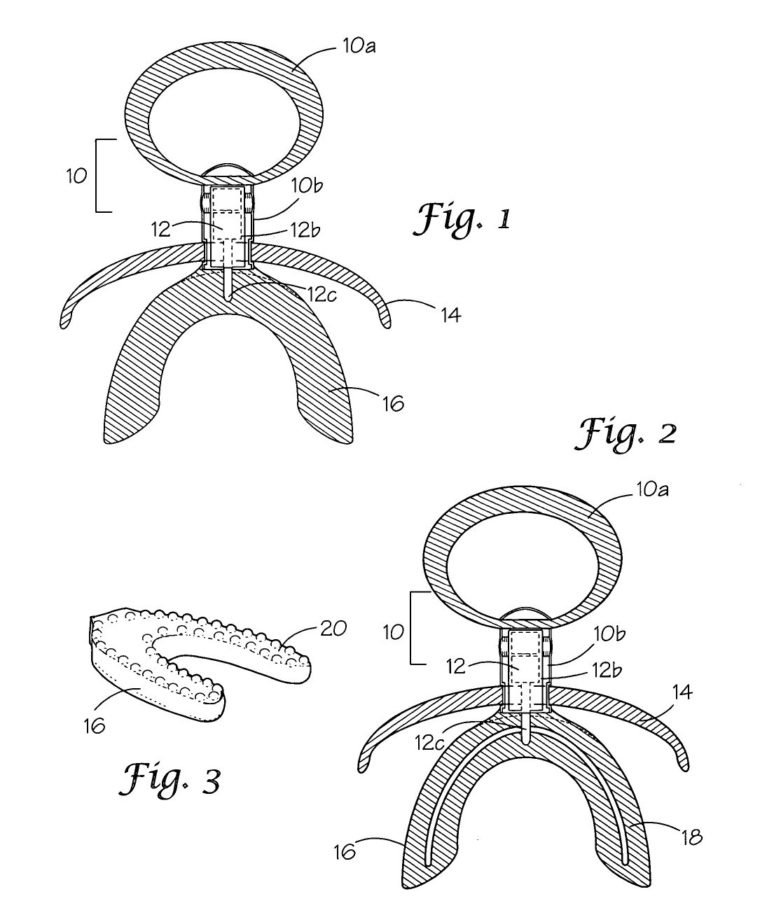

As shown in FIG. 1 a vibrating pacifier comprises a holder 10. The holder 10 has a circular holding section 10a and a housing section 10b, a battery operated motor 12 housed within the housing section 10b of the holder 10, wherein the motor 12 has a vibrating end 12b, a shield 14 that surrounds the housing section of the holder 10b, and a mouthpiece 16 shaped to conform to the shape of a child's gums that is attached to the housing section 10b of the holder 10 and that is further attached to the vibrating end 12b of the motor 12. The motor 12 can be any battery operated motor that would fit within the housing of the pacifier 10b. The motor 12 would have a vibrating means 12c attached to the vibrating end 12b that would attach to the mouth piece 16. The above elements would be secured together by means know in the art so that the elements cannot be separated once they are attached, e.g. using an adhesive to attach the elements together.

Ideally, the mouthpiece 16 is made of a resilient plastic, rubber, or of a resilient polymer. As seen in FIG. 3, the mouthpiece 16 can have a plurality of bumps 20 located on the sides of the mouthpiece 16 that conform to the gums of the user.

Ideally, the motor 12 is adjusted to vibrate at a rate between 1 and 100 cycles per second. The motor 12 would run for a set period of time once activated, e.g. a 5 minute period. The motor's 12 on/off switch can be incorporated in to the pacifier so that by simply squeezing the holders housing 10b the motor 12 would be turned on. The motor 12 would automatically turn off after a set period of time. Different on/off switches can be used with this device, such switches are known in the art.

As shown in FIG. 2, another embodiment of the invention would have a U-shaped wire 18 running through the center of the mouthpiece's body 16 and attaching from the center of the mouthpiece 16 to the vibrating end of the motor 12b. This configuration ensures that the mouthpiece vibrates uniformly along the length of the mouthpiece 16.

The shield 14 is made of a hard plastic or polymer. The shield 14 can be solid or have holes defined within so that air can reach the skin of the child using the pacifier.

An advantage of the present invention is that it relieves the pain a child experiences when teething because of the configuration of the U-shaped biting element of this invention.

Another advantage of this invention is that it provides a child with a device that can be bitten evenly, thereby preventing teeth displacement.

A further advantage of this invention is that it provides a device that a child can maintain in his mouth with out the aid of his hands.

Yet, another advantage of this invention is that it provides a device that will automatically turn off after preset period.

Lastly, another advantage of this invention is that it provides a device that will soothe a child while going to sleep.

Therefore, the forgoing description is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A vibrating pacifier comprising:
a holder, the holder having circular holding section and a housing section;
a battery operated motor housed within the housing section of the holder, wherein the motor has a vibrating end;
a shield surrounding the body of the housing section of the holder;
a mouthpiece shaped to conform to the shape of a child's gums that is attached to the housing section of the holder and that is further attached to the vibrating end of the motor.

2. The vibrating pacifier of claim 1, wherein the mouthpiece has a U-shaped wire running through the center of the mouthpiece's body and attaching from the center of the mouthpiece to the vibrating end of the motor.

3. The vibrating pacifier of claim 2, wherein the sections of the mouthpiece that conform to the shape of a child's gums have a plurality of bumps extending outward from the mouthpiece.

4. The vibrating pacifier of claim 3, wherein the motor can be adjusted to vibrate at different cycles.

5. The vibrating pacifier of claim 4, wherein the mouthpiece is made of a resilient plastic material.

6. The vibrating pacifier of claim 1, wherein the sections of the mouthpiece that conform to the shape of a child's gums have a plurality of bumps extending outward from the mouthpiece.

7. The vibrating pacifier of claim 6, wherein the motor can be adjusted to vibrate at different cycles.

8. The vibrating pacifier of claim 7, wherein the mouthpiece is made of a resilient plastic material.

9. The vibrating pacifier of claim 1, wherein the motor, after being turned on, automatically shuts off after a preset period.

10. The vibrating pacifier of claim 9, wherein the mouthpiece has a U-shaped wire running through the center of the mouthpiece's body and attaching from the center of the mouthpiece to the vibrating end of the motor.

11. The vibrating pacifier of claim 10, wherein the sections of the mouthpiece that conform to the shape of a child's gums have a plurality of bumps extending outward from the mouthpiece.

12. The vibrating pacifier of claim 11, wherein the motor can be adjusted to vibrate at different cycles.

13. The vibrating pacifier of claim 12, wherein the mouthpiece is made of a resilient plastic material.

14. The vibrating pacifier of claim 9, wherein the sections of the mouthpiece that conform to the shape of a child's gums have a plurality of bumps extending outward from the mouthpiece.

15. The vibrating pacifier of claim 14, wherein the motor can be adjusted to vibrate at different cycles.

16. The vibrating pacifier of claim 15, wherein the mouthpiece is made of a resilient plastic material.
